(19) United States
(12) Patent Application Publication
(10) Pub. No.: US 2020/0171924 A1
(43) Pub. Date: Jun. 4, 2020

(54) AIR SUPPLY UNIT

(71) Applicant: MAHLE International GmbH, Stuttgart (DE)

(72) Inventors: Joerg KILIAN, Renningen (DE); Anshuman SHEVADE, Mumbai (IN)

(73) Assignee: MAHLE International GmbH, Stuttgart (DE)

(21) Appl. No.: 16/784,808

(22) Filed: Feb. 7, 2020

Related U.S. Application Data
(63) Continuation of application No. PCT/EP2017/069924, filed on Aug. 7, 2017.

(51) Int. Cl. B60H 3/06; B60H 1/00

(52) U.S. Cl. CPC B60H 3/0608; B60H 2003/065; B60H 1/00564; B60H 1/00521

(57) ABSTRACT

An air supply unit, in particular for a heating, ventilation or air-conditioning unit in particular of a motor vehicle, an includes at least one air inlet, an air filter unit and a blower unit and an air outlet, wherein the filter unit comprises a filter housing in which a filter support is provided to support a filter element, which is located within the filter housing and which is supported within the filter housing by the filter support, wherein the filter support comprises an air guide for guiding air.

This nonprovisional application is a continuation of International Application No. PCT/EP2017/069924, which was filed on Aug. 7, 2017, and which is herein incorporated by reference.

### BACKGROUND OF THE INVENTION

### Field of the Invention

The present invention relates to an air supply unit, in particular for a heating, ventilation or an air-conditioning unit of a motor vehicle.

### Description of the Background Art

Air supply units of air-conditioning units are known in the art especially for motor vehicles. Such an air supply unit comprises an air inlet, an air filter unit and a blower unit and an air outlet. The blower unit sucks air through the air inlet to the air filter unit and supplies the air through the air outlet to subsequent units especially of a heating, ventilation or air-conditioning unit. Such subsequent units downstream of the blower are e.g. a cooling unit with an evaporator and/or a heating unit with a heater core and/or a mixing unit in which a cooled air flow and a heated air flow might be mixed and/or an air distribution unit, which distributes air to different outlet channels or outlet openings to supply air e.g. to a passenger compartment of the motor vehicle.

The blower unit produces a strong air mass flow through the air inlet unit and through the air filter unit upstream of the blower unit which causes the creation of noise in the air supply unit.

### SUMMARY OF THE INVENTION

It is therefore an object of the present invention to provide an air supply unit with a reduced noise emission.

According to an exemplary embodiment of the invention an air supply unit is provided, in particular for a heating, ventilation or air-conditioning unit in particular of a motor vehicle, comprising an air inlet, an air filter unit and a blower unit and an air outlet, wherein the filter unit comprises a filter housing in which a filter support is provided to support a filter element, which is located within the filter housing and which is supported within the filter housing by the filter support, characterized in that the filter support comprises an air guide for guiding air. This arrangement allows a directed air flow within the air supply unit from the air filter unit to the blower unit such that the noise created by the air flow is reduced.

According to an embodiment of the invention it is of advantage that the filter support is provided as a filter support grid. This allows a stable and safe arrangement of the filter element over lifetime of the filter element and defines a place of the filter element which allows an easy and quick replacement of the filter element during a service of the filter element and a stable support of the filter element.

Furthermore it is of advantage that the air guide is provided as an air guiding grid. Therefore the air guiding grid acts as an air guiding element which is integrated within the filter support grid. Therefore the air guiding grid may additionally act as support grid and air guiding grid.

Therefore it is of advantage that the air guiding grid is integrated with the filter support grid. Therefore no additional place and volume is required which otherwise would increase the necessary space in the air supply unit.

Further, it is of advantage that the air guiding grid with its integrated filter support grid is made by injection molding. Therefore the integrated part can easily be made by injection molding to allow easy manufacturing and easy integration.

Furthermore it is of advantage that the filter support grid comprises at least one support fillet or a plurality of support fillets. The mentioned fillets allow the support of the filter element without a serious blocking of the filter element outlet area. Therefore the support grid reduces the influence on the air flow through the filter element as much as possible.

The support fillet can be a straight or curved or arched or circular fillet. Therefore different arrangements of such fillets are possible, especially arrangements of cross-like arranged fillets. Such structures of fillets allow a good support of the filter element.

To support the filter element it is of advantage that at least some of the support fillets are connected to each other. This allows a stable structure to support the filter element.

The air guiding grid can comprise at least one air guiding vane or a plurality of air guiding vanes. Therefore the guiding grid allows a good air guiding capability.

The air guiding vane can be a straight or curved or arched or circular vane. Therefore different arrangements of such air guiding vanes are possible to deflect the air flow with such air guiding vanes.

Therefore it is of advantage that at least some of the air guiding vanes are connected to each other and/or to at least one support fillet. This arrangement allows a strong structure to create a predefined influence on the air flow.

Furthermore it is of advantage that at least some of the air guiding vanes are aligned in parallel to each other. This arrangement allows a stronger influence on the air flow.

Additionally it is of advantage that the air guiding vanes which are aligned in parallel to each other are located at a predefined distance from each other. This allows a predefined influence of the air flow and a defined deflection of the air at the parallel aligned air guiding vanes.

Furthermore it is of advantage that the air guiding vanes are angled with respect to the plane which is defined by the support grid. According to the angle of the air guiding vanes a deflection of the air is resulting.

Additionally it is of advantage that the air guiding vanes are located in a defined section of the support grid. This allows a predefined deflecting effect on the air at different or at specific sections of the air support grid.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a sectional view of the air supply unit,

FIG. 2 shows a perspective view of the air supply unit,

FIG. 3 shows a perspective view of the filter housing with a filter support grid and an air guiding grid,

FIG. 4 shows a perspective view of an embodiment of a filter support grid,

FIG. 5 shows a perspective view of the filter support grid of FIG. 4 arranged in the filter housing,

FIG. 6 shows a perspective view of another embodiment of a filter support grid,

FIG. 7 shows a perspective view of the filter support grid of FIG. 6 arranged in the filter housing,

FIG. 8 shows a perspective view of another embodiment of a filter support grid arranged in a filter housing,

FIG. 9 shows a plan view of the filter support grid of FIG. 8,

FIG. 10 shows a plan view of a detail of the filter support grid of FIG. 8,

FIG. 11 shows a cross-section of the air guiding grid of FIG. 8,

FIG. 12 shows a perspective view of another embodiment of a filter support grid arranged in a filter housing,

FIG. 13 shows a perspective view of another embodiment of a filter support grid arranged in a filter housing,

FIG. 14 shows a cross-section of the air guiding grid of FIG. 13,

FIG. 15 shows a perspective view of another embodiment of a filter support grid arranged in a filter housing,

FIG. 16 shows a cross-section of the air guiding grid of FIG. 15,

FIG. 17 shows a perspective view of another embodiment of a filter support grid arranged in a filter housing,

FIG. 18 shows perspective view of the air guiding grid of FIG. 17,

FIG. 19 shows a perspective view of another embodiment of a filter support grid arranged in a filter housing,

FIG. 20 shows perspective view of the air guiding grid of FIG. 19,

FIG. 21 shows a perspective view of another embodiment of a filter support grid arranged in a filter housing,

FIG. 22 shows a cross-section of the air guiding grid of FIG. 21,

FIG. 23 shows a perspective view of another embodiment of a filter support grid arranged in a filter housing,

FIG. 24 shows a perspective view of the filter support grid of FIG. 23,

FIG. 25 shows a sectional view of the filter support grid of FIG. 23,

FIG. 26 shows a sectional view of the filter support grid of FIG. 23,

FIG. 27 shows a perspective view of another embodiment of a filter support grid arranged in a filter housing,

FIG. 28 shows a cross-section of the air guiding grid of FIG. 27,

FIG. 29 shows a perspective view of another embodiment of a filter support grid arranged in a filter housing, and

FIG. 30 shows a cross-section of the air guiding grid of FIG. 29.

### DETAILED DESCRIPTION

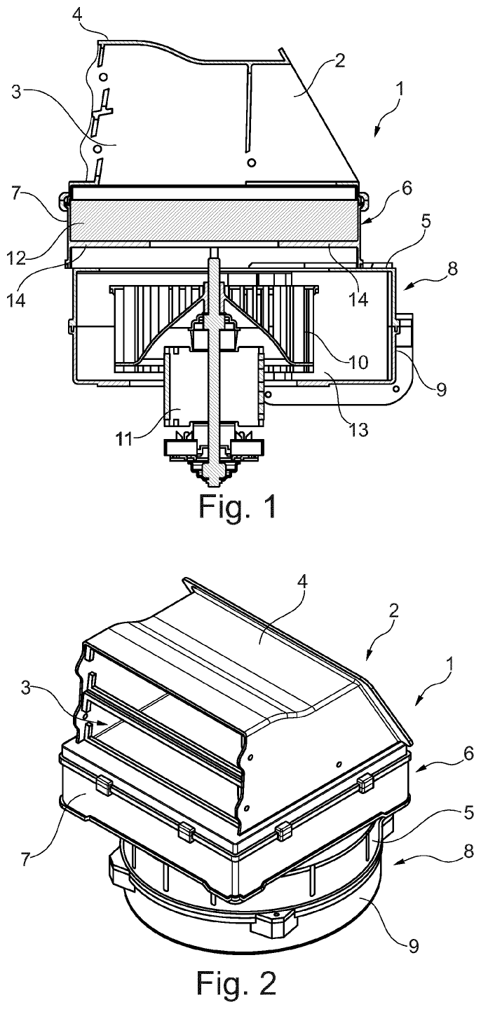

FIG. 1 shows a sectional view of the air supply unit 1 especially of a heating, ventilation or air-conditioning unit in particular of a motor vehicle. FIG. 2 shows a perspective view of the air supply unit 1.

The air supply unit 1 comprises an air inlet 2 and optionally a second air inlet 3 to allow air to be sucked inside the air supply unit 1. The air inlet 2 is preferably an air inlet for fresh air from the outside of the motor vehicle and the optional second air inlet 3 is preferably an air inlet for recirculated air from a passenger compartment of the motor vehicle. In another embodiment of the air supply unit the air inlet 2 might be an air inlet for recirculated air and the second air inlet 3 might be an air inlet for fresh air.

The air inlet 2 and/or the air inlet 3 are arranged in an air inlet housing 4 which is part of the housing 5 of the air supply unit 1.

Preferably there is an air controller provided which allows the control of air through the air inlet 2. Furthermore there might be an additional air controller to control an air flow through the air inlet 3. Preferably there is provided a mixer within the air inlet housing like a mixing flap to create a blend of air from the air inlet 2 and from the air inlet 3. According to a preferred embodiment the mixer is located within the air inlet housing 4. In another embodiment the air mixer is realized by using the air controller 6 of the air inlet 2 and the other air controller of the air inlet 3.

The air supply unit 1 comprises furthermore an air filter unit 6 with a filter housing 7 and a blower unit 8 with a blower housing 9. Within the blower housing 9 a blower wheel 10 is located which is driven by a motor 11. Due to the driven blower wheel 10 the air is sucked from the air inlets 2, 3 through a filter element 12 within the filter housing 7 and is delivered to an air outlet 13.

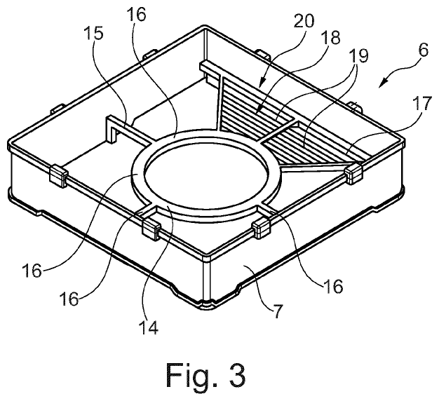

The filter unit 6 comprises a filter housing 7 in which a filter support 14 is provided to support the filter element 12, which is located within the filter housing 7 and which is supported within the filter housing 7 by the filter support 14. In FIG. 1 it can be seen that the filter element 12 is located within the filter housing. In FIG. 3 it can be seen that the filter housing comprises a filter support 14, which carries the filter element 12 within the housing 7. The filter support 14 is realized as a filter support grid 15, which comprises at least one or a plurality of support fillets 16. In the shown embodiment the support fillet are provided as straight or curved or arched or circular fillets. In the embodiment of FIG. 3 at least some of the support fillets 16 are connected to each other to generate the support grid.

As can be seen in FIG. 3 the filter support 14 comprises an air guide 17 for guiding air. The air guide 17 is provided as an air guiding grid 18 as can be seen from FIG. 3. As an advantageous embodiment the air guiding grid is integrated with the filter support grid to one part and preferably the air guiding grid 18 with the integrated filter support grid 15 is made by injection molding. Furthermore it might be of advantage that the filter housing 7 and the support 14 and the air guide 17 are made as one part e.g. by injection molding.

In FIG. 3 the air guide 17 is made as a series of air guiding vanes 19 which are aligned in parallel to each other creating a section 20 of air guiding vanes 19.

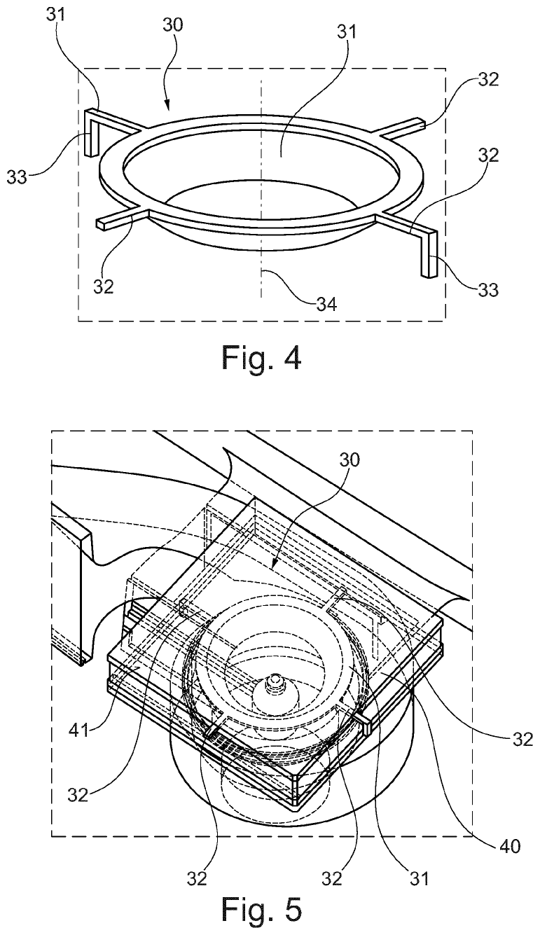

FIG. 4 shows an embodiment of a filter support grid 30 with a circular support fillet 31 and with straight support fillets 32 which are aligned in a radial direction from the circular fillet 31. At the end of a straight fillet 32 there might be an extension 33 in an axial direction with respect to a symmetry axis 34 of the circular fillet 31. The extension is provided as air guiding vane. The circular fillet 31 has a tapered shape which narrows in the direction of the axis 34 in the downward direction. FIG. 5 shows the support grid within the filter housing 40. As can be seen the filter element 41 is located on top of the filter support grid 30 and is carried by the filter support 30.

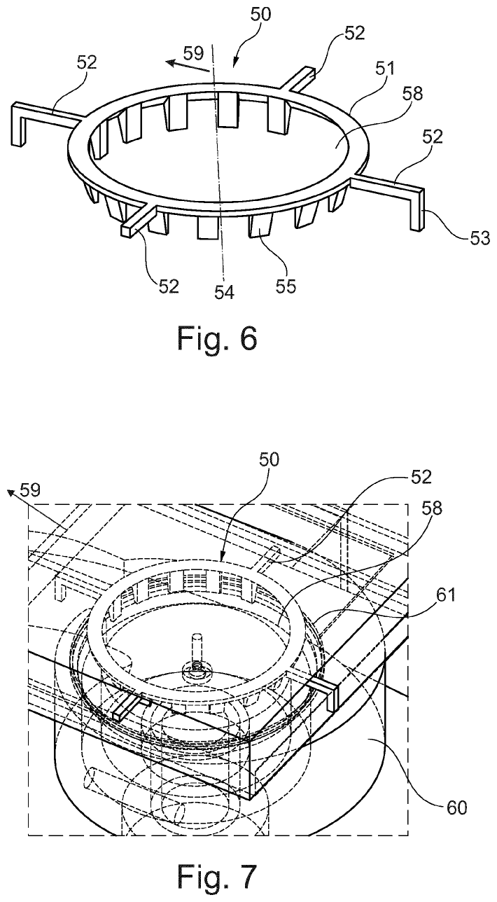

FIG. 6 shows another embodiment of a filter support grid 50 with a circular support fillet 51 and with straight support fillets 52 which are aligned in a radial direction from the circular fillet 51. At the end of a straight fillet 52 there might be an extension 53 in an axial direction with respect to a symmetry axis 54 of the circular fillet 51. The circular fillet 51 has a tapered shape with an amount of tooth 55 arranged in a circumferential direction of the circular fillet 51 which narrows in the direction of the axis 54 in the downward direction. The tapered tooth are designed as air guiding vanes. FIG. 7 shows the support grid 50 within the filter housing 60. As can be seen the filter element 61 is located on top of the filter support grid 50 and is carried by the filter support 50 being realized as filter support grid 50.

As can be seen in the FIG. 6 and FIG. 7. The tooth 55 are arranged only in a defined area of the circular fillet 51. There is an area 58 with no tooth. This area 58 is located in a segment of the fillet 51 which is located against the air flow direction 59.

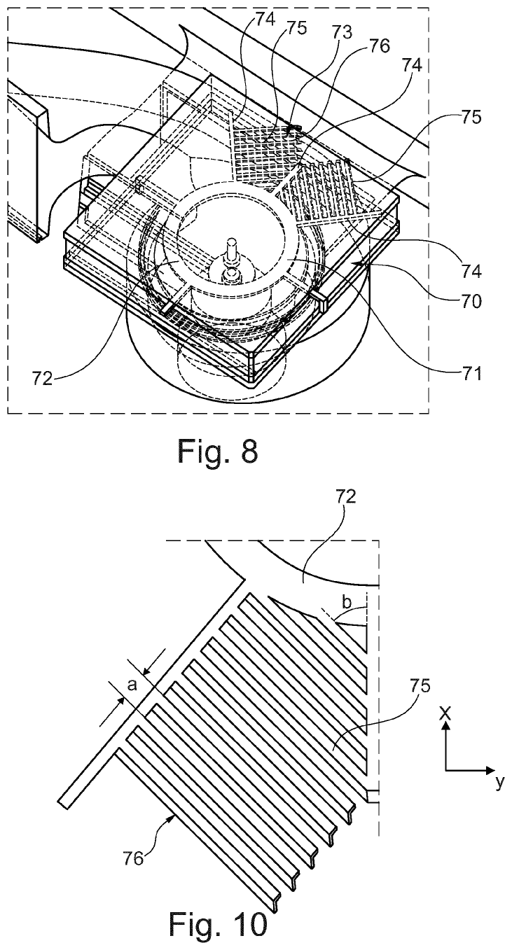

FIG. 8 shows a perspective view of another embodiment of a filter support grid 71 arranged in a filter housing 70. The filter support grid 71 comprises fillets 72 and an air guiding grid 73 is provided. The air guiding grid 73 comprises three fillets 74 which are directed in a radial direction from a circular fillet 72. Between two of the respective fillets 74 air guiding vanes 75 are arranged in parallel to each other creating two sections 76 of air guiding vanes 75. The vanes of the two sections 76 are aligned in a right angle to each other.

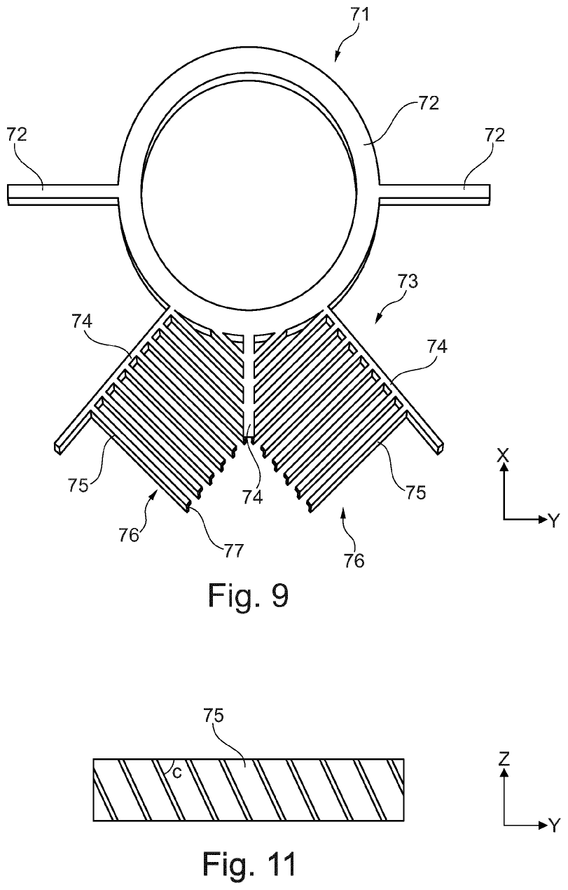

FIG. 9 shows a detailed view of the filter support grid 71 with the air guiding grid 73. The ends 77 of the fillets of the two sections 76 are arranged together with the outer fillets of the two sections in a v-shape.

FIG. 10 shows that the distance between the vanes 75 is a, which is approximately between 5 and 10 mm, especially 7.5 mm. FIG. 10 shows that the vanes 75 are angled by the angle b, which is approximately between 45° and 50°, especially 47.5°. Furthermore the FIG. 11 shows that the vanes 75 are angled by the angle c, which is approximately between 60° and 70°, especially 63°.

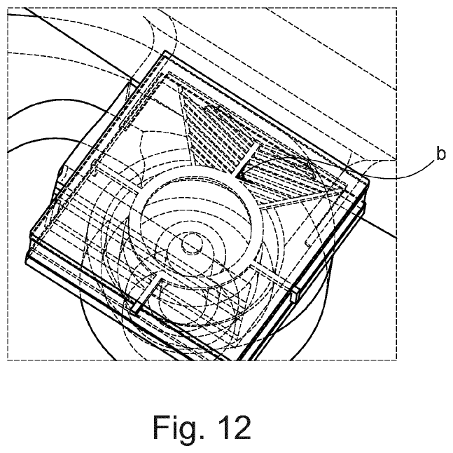

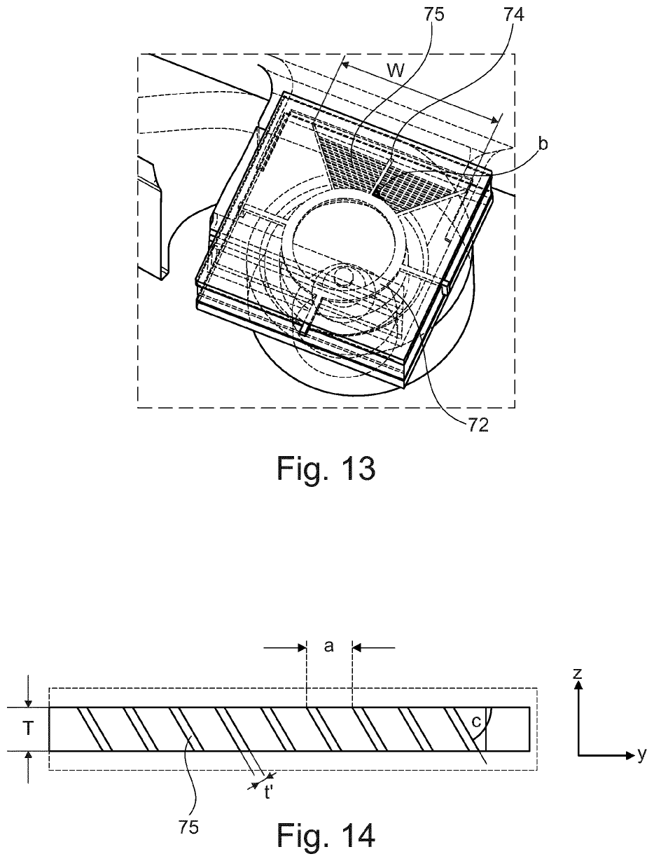

FIG. 12 shows a perspective view of another embodiment of a filter support grid arranged in a filter housing 70, wherein the angle b is more than 90° compared to the definition of angle b in FIG. 13. For this embodiment, a is 5 to 10 mm, especially 7.5 mm, b is 100° to 110°, especially 105°, c is 60 to 70 degrees, especially 63 degrees.

FIG. 13 shows a perspective view of another embodiment of a filter support grid 71 arranged in a filter housing, wherein the angle b is 90° as defined in FIG. 13. The angle b is the angle between the central fillet 74 and the vanes 75. The air guiding grid has a width w in the plane perpendicular to the axis of the blower wheel, wherein the width w is smaller than the extension of the filter housing 70 in this direction.

According to FIG. 14 the distance a between the vanes 75 is 5 mm, the angle c is approximately 60°. For this embodiment a is 3 to 10 mm, especially 5 mm, b is 80° to 100°, especially 90°, c is 55° to 65°, especially 60°. The vanes have a thickness t′ which is between 0.5 mm and 5 mm, especially 1 mm, 1.5 mm, 2 mm, 2.5 mm, 3 mm or 3.5 mm. The filter support grid has a thickness T which is between 0.5 mm and 5 mm, especially 1 mm, 1.5 mm, 2 mm, 2.5 mm, 3 mm or 3.5 mm.

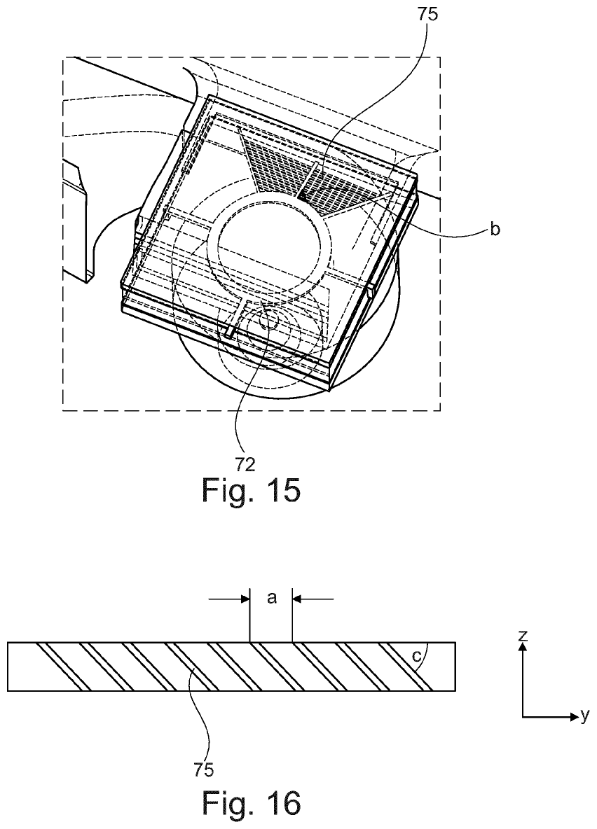

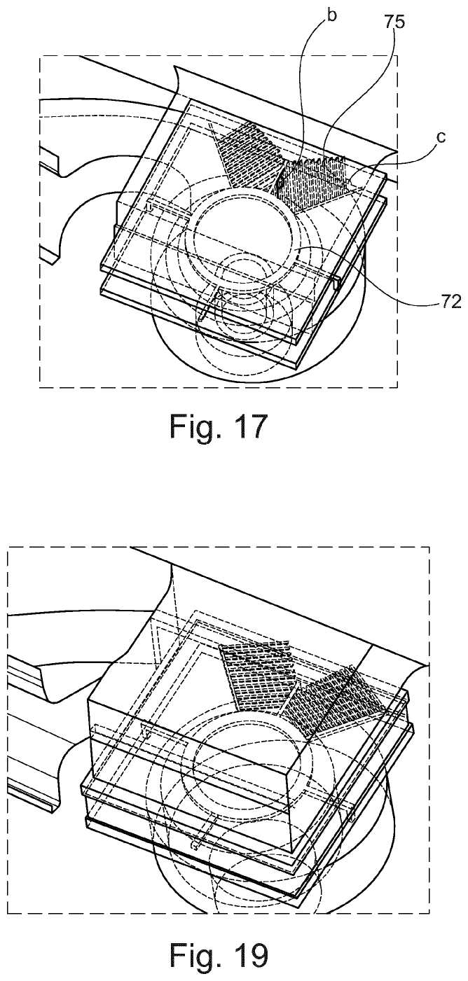

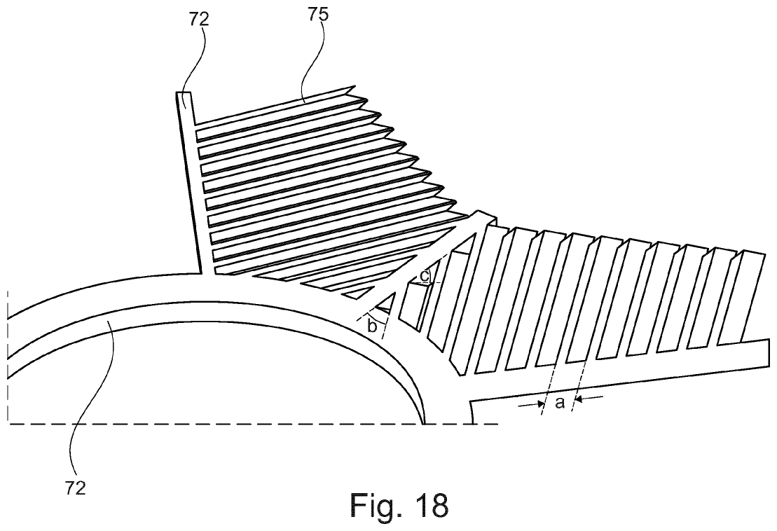

FIG. 15 shows a perspective view of another embodiment of a filter support grid arranged in a filter housing, wherein the angle b is 90° as defined in FIG. 13. According to FIG. 16 the distance a between the vanes 75 is 5 mm, the angle c is approximately 45°. For this embodiment a is 3 to 10 mm, especially 5 mm; b is 80° to 100°, especially 90°; c is 40° to 50°, especially 45°. FIG. 17 shows a perspective view of another embodiment of a filter support grid arranged in a filter housing, wherein the angle b in the xy-plane is 30° is smaller compared to the definition of angle b in FIG. 13. According to FIG. 18 the distance a between the vanes 75 is 6 mm, the angle c in the yz-plane is approximately 35°. For this embodiment a is 3 to 10 mm, especially 6 mm; b is 20° to 40°, especially 30°; c is 30° to 40°, especially 35°.

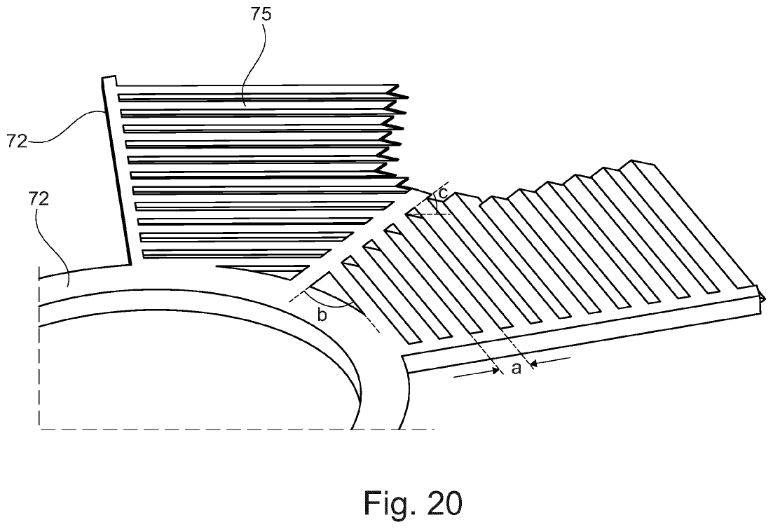

FIG. 19 shows a perspective view of another embodiment of a filter support grid arranged in a filter housing, wherein the angle b in the xy-plane is 60° is smaller compared to the definition of angle b in FIG. 13. According to FIG. 20 the distance a between the vanes 75 is 6 mm, the angle c in the yz-plane is approximately 35°. For this embodiment a is 3 to 10 mm, especially 6 mm; b is 50° to 70°, especially 60°; c− is 30° to 40°, especially 35°.

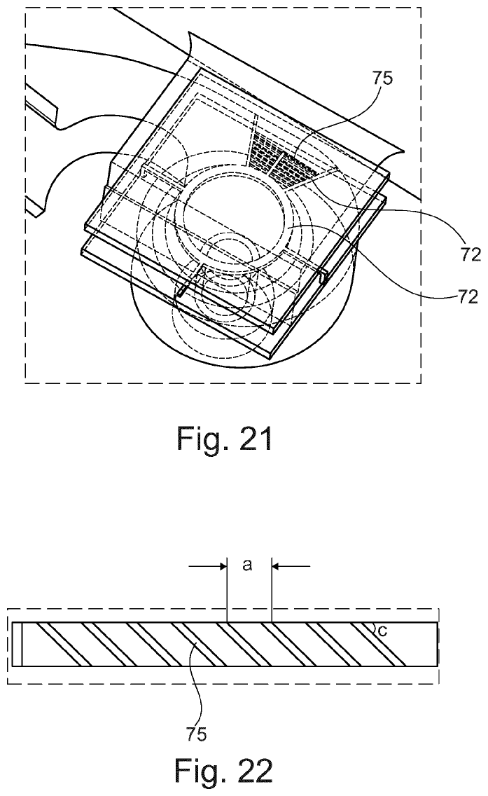

FIG. 21 shows a perspective view of another embodiment of a filter support grid arranged in a filter housing, wherein the angle b in the xy-plane is 90° as defined in FIG. 13. According to FIG. 22 the distance a between the vanes 75 is 5 mm, the angle c in the yz-plane is approximately 45°. Side fillets are shiftet inwards for 15 mm compared to the embodiment shown in FIG. 15. For this embodiment a is 3 to 10 mm, especially 5 mm; b is 80° to 100°, especially 90°, c is 40° to 50°, especially 45°.

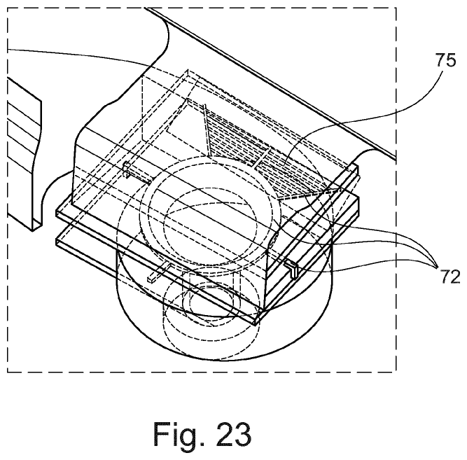

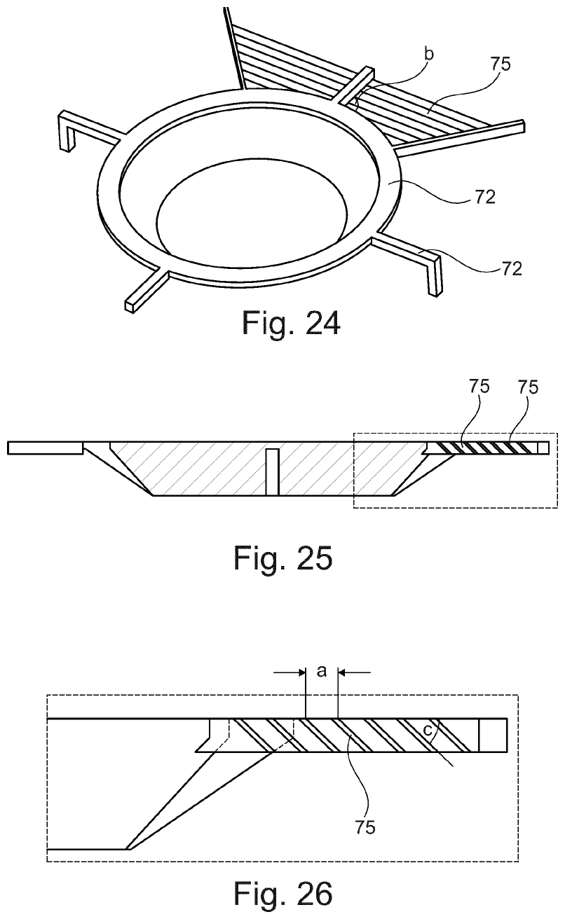

The FIGS. 23 to 26 show a filter support of FIG. 4 with an air guiding grid with vanes 75, wherein the angle b in the xy-plane is 90° as defined in FIG. 13. According to FIGS. 25 to 26 the distance a between the vanes 75 is 5 mm, the angle c in the yz-plane is approximately 45°. For this embodiment a is 3 to 10 mm, especially 5 mm, b is 80° to 100°, especially 90, c is 40° to 50°, especially 45°:

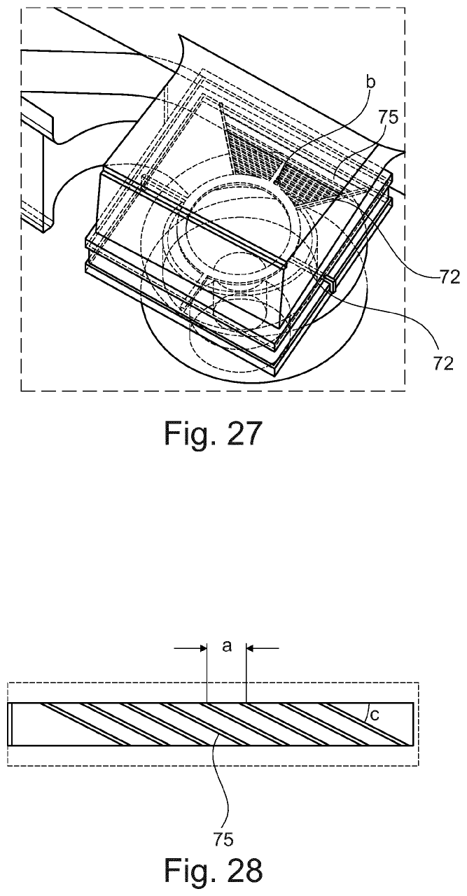

FIG. 27 shows a perspective view of another embodiment of a filter support grid arranged in a filter housing, wherein the angle b in the xy-plane is 90° as defined in FIG. 13. According to FIG. 28 the distance a between the vanes 75 is 5 mm, the angle c in the yz-plane is approximately 30°. For this embodiment a is 3 to 10 mm, especially 5 mm, b is 80° to 100°, especially 90°, c is 25° to 35°, especially 30°.

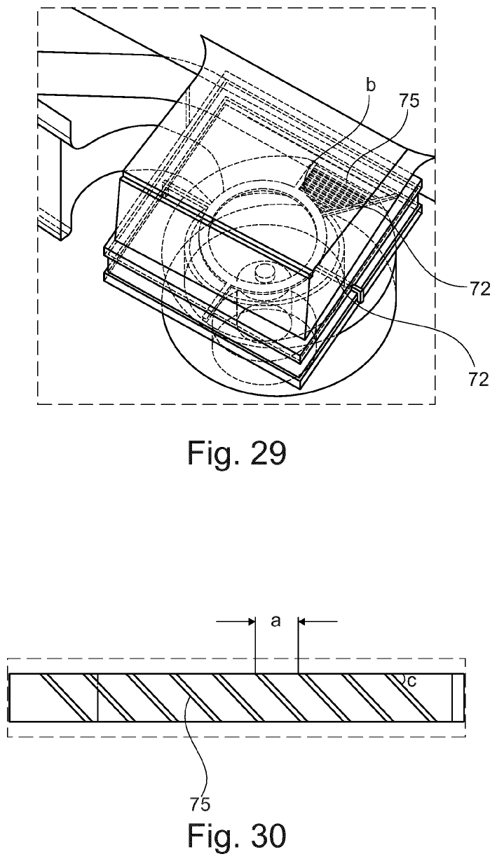

FIG. 29 shows a perspective view of another embodiment of a filter support grid arranged in a filter housing, wherein only one section 76, based on the embodiment of FIG. 15 is provided. Furthermore the angle b in the xy-plane is 90° as defined in FIG. 13. According to FIG. 30 the distance a between the vanes 75 is 5 mm, the angle c in the yz-plane is approximately 45°. For this embodiment a is 3 to 10 mm, especially 5 mm, b is 80° to 100°, especially 90°, c is 40° to 50°, especially 45°.

While the invention has been explained with reference to the Figures, it will be clear to those skilled in the arts to which it pertains that a variety of modifications and changes can be made thereto without departing from the scope of the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An air supply unit for a heating, ventilation or air-conditioning unit of a motor vehicle, the air supply unit comprising:
at least one air inlet;
an air filter unit;
a blower unit; and
an air outlet,
wherein the filter unit comprises a filter housing in which a filter support is provided to support a filter element, which is located within the filter housing and which is supported within the filter housing by the filter support, and
wherein the filter support comprises an air guide for guiding air.

2. The air supply unit according to claim 1, wherein the filter support is provided as a filter support grid.

3. The air supply unit according to claim 1, wherein the air guide is provided as an air guiding grid.

4. The air supply unit according to claim 3, wherein the air guiding grid is integrated with the filter support grid.

5. The air supply unit according to claim 4, wherein the air guiding grid with its integrated filter support grid is made by injection molding.

6. The air supply unit according to claim 1, wherein the filter support grid comprises at least one support fillet or a plurality of support fillets.

7. The air supply unit according to claim 6, wherein the support fillet is a straight or curved or arched or circular fillet.

8. The air supply unit according to claim 6, wherein at least some of the support fillets are connected to each other.

9. The air supply unit according to claim 1, wherein the air guiding grid comprises at least one air guiding vane or a plurality of air guiding vanes.

10. The air supply unit according to claim 9, wherein the air guiding vane is a straight or curved or arched or circular vane.

11. The air supply unit according to claim 9, wherein at least some of the air guiding vanes are connected to each other and/or to at least one support fillet.

12. The air supply unit according to claim 1, wherein at least some of the air guiding vanes are aligned in parallel to each other.

13. The air supply unit according to claim 12, wherein the air guiding vanes which are aligned in parallel to each other are located at a predefined distance from each other.

14. The air supply unit according to claim 13, wherein the predefined distance is in a range between 3 mm and 10 mm, or 5 mm, 6 mm or 7.5 mm.

15. The air supply unit according to claim 1, wherein the air guiding vanes are angled with an angle with respect to the plane which is defined by the support grid.

16. The air supply unit according to claim 15, wherein the angle is in the range between 25° to 70°, or 30°, 35°, 45°, 60° or 63°.

17. The air supply unit according to claim 1, wherein the air guiding vanes are located in a defined section of the support grid.

18. The air supply unit according to claim 1, wherein an angle in the plane of the support grid is provided between a fillet and the vanes.

19. The air supply unit according to claim 18, wherein the angle is in the range between 20° to 110°, or 30°, 60°, 90° or 105°.

20. The air supply unit according to claim 1, wherein the support grid and/or the vanes have a thickness, wherein the thickness is between 0.5 mm and 5 mm, 1 mm, 1.5 mm, 2 mm, 2.5 mm, 3 mm or 3.5 mm.

21. The air supply unit according to claim 1, wherein the support grid comprises a circular fillet and wherein vanes are provided which are arranged on the circular fillet and protruding in a direction to the blower wheel or to the blower housing.

22. The air supply unit according to claim 1, wherein the support grid comprises a circular fillet and a tapered vane is provided which is arranged on the circular fillet and protruding in the direction to the blower wheel or to the blower housing.
